(19) United States
(12) Patent Application Publication
(10) Pub. No.: US 2005/0228563 A1
(43) Pub. Date: Oct. 13, 2005

(54) SYSTEM AND METHOD FOR FACILITATING THE DESIGN OF A VIBRATION CONTROL DEVICE

(75) Inventors: Suhale Manzoor, Cement City, MI (US); Jerry L. Zabonick, Coldwater, MI (US)

Correspondence Address: SNELL & WILMER;ONE ARIZONA CENTER, 400 EAST VAN BUREN, PHOENIX, AZ, 850040001, US

(73) Assignee: EAGLEPICHER AUTOMOTIVE HILLSDALE DIVISION, Hillsdale, MI (US)

(21) Appl. No.: 10/907,013

(22) Filed: Mar. 16, 2005

Related U.S. Application Data
(60) Provisional application No. 60/553,760, filed on Mar. 16, 2004.

(51) Int. Cl. B60G 23/00

(52) U.S. Cl. 701/37

(57) ABSTRACT

The invention includes systems and methods for designing a vibration control device. Included is a design suite having two or more of a Holzer analysis module, a sine-lock design module, a standard torsional damper design module, a common vertex torsional damper design module, a linear damper design module, a torsional isolator design module, an inertia calculator, a rubber database, a rubber distortion calculator, a mold design module, a joint analysis calculator, a compression set calculator, a assembly fixture module, and a mass scaling calculator consolidated on a single computer platform. Particular embodiments include the Holzer analysis module with one or more of the sine-lock design module, the standard torsional damper design module, the common vertex torsional damper design module, the linear damper design module, and the torsional isolator design module consolidated on the single computer platform.

### CROSS-REFERENCE TO RELATED APPLICATION

This application claims priority to U.S. Provisional Application No. 60/553,760 filed Mar. 16, 2004, which provisional application, in its entirety, is hereby incorporated by reference.

### FIELD OF INVENTION

This invention generally relates to design and optimization of vibration control devices. Specifically, the present invention relates to methods and systems for facilitating the design of vibration control devices, such as, for example, standard torsional dampers, common vertex torsional dampers, linear dampers, and torsional isolators.

### BACKGROUND OF INVENTION

Many methods and algorithms for the design of vibration control devices are known in the art. Historically, however, the design of a vibration control device has required an engineer to manage a large amount of design data and other information for each phase of design—for example, Holzer analysis, structural design, performance modeling, materials considerations, and device analysis. In particular, in the performance modeling and device analysis phases, an engineer has traditionally been required to utilize simulation, modeling and/or graphics software separate and apart from any software or other tools he or she has utilized in the other aspects of device design, which contributes to design error and inefficiencies in timing, scheduling, and cost. In fact, oftentimes design data must be sent to outside vendors for modeling and/or testing during the design process, which can contribute significantly to the cost and timing of a particular project.

What is needed in the art is a method and system for facilitating the design of vibration control devices that consolidates the various phases of device design into a single application, and which allows for a reasonably “seamless” design and optimization process for vibration control devices. In particular, a system that incorporates graphical analysis capabilities and thus eliminates the need for separate simulation software or testing applications.

### SUMMARY OF INVENTION

The present invention provides a system and method for facilitating the design of vibration control devices that consolidates the various phases of device design into a single application and provides for easy access to and analysis of design data. The present invention allows for a reasonably “seamless” design and optimization process for vibration control devices, such as, for example, standard torsional dampers, common vertex torsional dampers, linear dampers, and torsional isolators.

In accordance with one exemplary embodiment of the invention, a design system is configured to optimize various user input variables to facilitate the design of a vibration control device, such as, for example, two or more of mass, inertia, contact area, device hub outer diameter, gap, contact width, frequency, and shear modulus.

In accordance with one aspect of an exemplary embodiment of the invention, a design system includes a module for calculating the inertia of a vibration control device that mitigates or eliminates the need for separate and laborious hand calculations or CAD-modeled calculations.

In accordance with one aspect of the present invention, advantages and disadvantages of noise, vibration and harshness (NVH) benefit, device weight, and device cost can be understood prior to hardware fabrication and evaluation. Moreover, effects of tuning frequency and operating temperatures can be understood during the design and release phase of development, prior to actual hardware fabrication and evaluation.

In accordance with another aspect of the present invention, existing vibration control device designs may be further optimized for cost, weight, and NVH benefits considering production variability. Moreover, effects of production variation and operating temperatures can be easily predicted.

In accordance with yet another aspect of the present invention, theoretical and/or actual properties of materials can be used to estimate both optimal and “real” performance values.

In accordance with yet another aspect of the present invention, optimal tuning characteristics for a vibration control device—namely, frequency and inertia—can be easily determined.

In accordance with yet another aspect of the present invention, design studies and graphics illustrate the effect of changes in variables, so design and budget decisions can be facilitated during the initial stages of device development.

In accordance with yet another aspect of an exemplary embodiment of the invention, a design system may be used as a training tool for new users in that it “automates” certain aspects of vibration control device design and provides verification outputs with feasibility indicators.

In accordance with another aspect of an embodiment of the invention, design studies and graphics illustrate the effect of changes in each user input variable and calculated output value such that design and/or budget decisions may be facilitated in-process.

These and other advantages of a design system and method according to various aspects and embodiments of the present invention will be apparent to those skilled in the art upon reading and understanding the following detailed description with reference to the accompanying drawing figures.

### BRIEF DESCRIPTION OF THE DRAWINGS

The subject matter of the present invention is particularly pointed out in the concluding portion of the written description. A more complete understanding of the present invention, however, may best be obtained by referring to the detailed description when considered in connection with the drawing figures, wherein like numerals denote like elements and wherein:

FIG. 1 illustrates an exemplary embodiment of a user interface module reflecting various functional aspects of the invention;

FIG. 2 illustrates the response of undamped and damped vibration systems, and reflects one general type of graphical output from an aspect of one embodiment of the invention;

FIG. 3 illustrates the relationship between any two of the six key torsional damper parameters when the other four are held constant;

FIG. 4 illustrates the relationship between any two of the five key linear damper parameters when the other three are held constant;

FIG. 5 is a flow diagram illustrating the three-step approach to the design of a vibration control device in accordance with aspects of an exemplary embodiment of the present invention; and

FIGS. 6 through 19 illustrate various user interface modules reflecting various functional aspects of another exemplary embodiment of the invention.

### DETAILED DESCRIPTION

The following detailed description refers to the accompanying drawing figures that illustrate exemplary embodiments of the present invention. Other embodiments are possible and modifications may be made to the illustrated embodiments without departing from the spirit and scope of the invention. Therefore, the following detailed description is not meant to limit the invention.

It will be apparent to one of ordinary skill in the art that the embodiments described hereinbelow may be implemented in many different embodiments of software, firmware, and hardware in the entities illustrated in the drawing figures. The actual software code or specialized hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein and the accompanying drawing figures with only a reasonable effort and without undue experimentation.

Moreover, the processes associated with the presented embodiments of the invention may be stored in any storage device, such as, for example, a computer system (non-volatile) memory, an optical disk, a magnetic tape, or magnetic disk. Furthermore, the processes may be programmed when the computer system is manufactured or via a computer-readable medium at a later date. Such a medium may include any of the forms listed above with respect to storage devices and may further include, for example, any suitable medium or combination of media now known or hereinafter developed.

In accordance with various aspects of the present invention, a design system for vibration control devices is provided that consolidates available vibration control device knowledge into a single application, and effectively incorporates the functionality of standalone modeling and simulation applications, database applications, and testing applications to accurately design and optimize vibration control devices. The portability and comprehensive utility of design systems configured in accordance with the various aspects of the present invention enables designers to interact easily with other designers, engineers, customers, and others during the device design process.

In accordance with an exemplary embodiment of the invention, a design system includes assembly fixture and graphics generation utilities to enable a user to visualize the effects of various mathematical variables on the design of a vibration control device and to understand their sensitivity to the system. Moreover, design systems configured in accordance with the various aspects of the present invention may serve as effective training tools to enable new users to understand the nuances of vibration control device design more time-effectively.

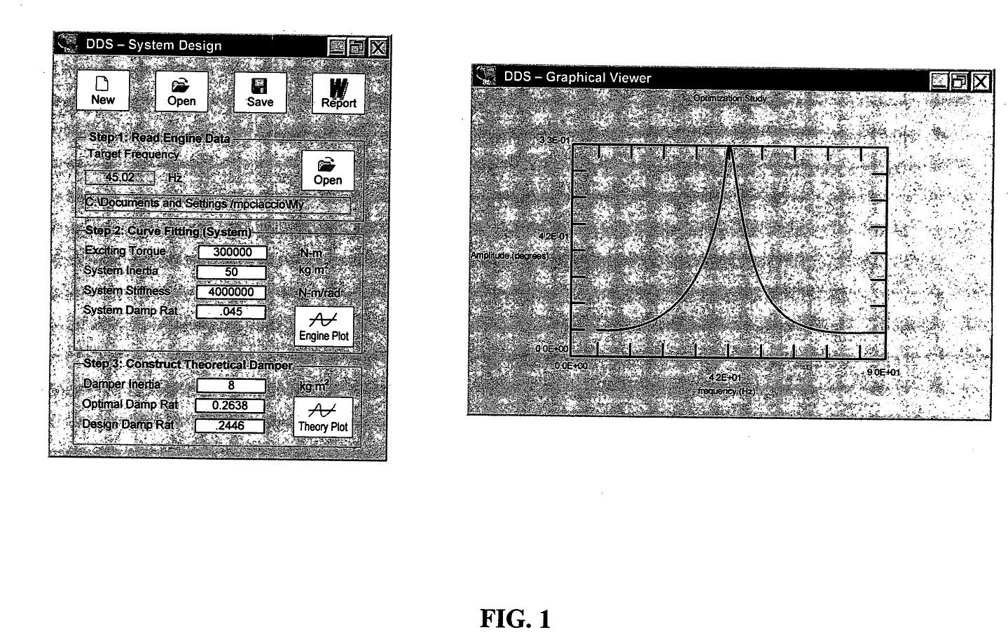

FIG. 1 illustrates the response of undamped and damped vibration systems, and reflects one general type of graphical output from an aspect of one embodiment of the invention. An optimally tuned damping system is a system where a single resonant amplitude frequency has been reduced to two equal and smaller amplitudes. Optimally tuning a particular system may or may not reduce the amplitude to an acceptable limit. In accordance with one aspect of the invention, the design system includes a assembly fixture module (such as that illustrated in FIG. 1) that takes the results of the Holzer analysis and vibration control device design modules of the design system and constructs a theoretical damper plot comparing the natural frequency and amplitude of the undamped system with the frequency and amplitude of a system damped with the device as designed. The user can then use the plot to determine whether the device as designed achieves the desired amount of damping. If the amplitude of the damped system curve is greater than an acceptable limit (i.e., the system in “under-tuned”), the user may return to the vibration control device design module and increase the mass of the damper, which will result in a lower amplitude curve for the redesigned device. If the amplitude of the damped system curve is less than an acceptable limit (i.e., the system in “over-tuned”), the user may return to the vibration control device design module and decrease the mass of the damper or change other variables to achieve a lower amplitude curve for the redesigned device. The present invention enables efficient optimization of vibration control device designs by eliminating the need for separate analysis, testing, and/or modeling products and by providing digital interaction between and among the various design modules to facilitate an iterative design process.

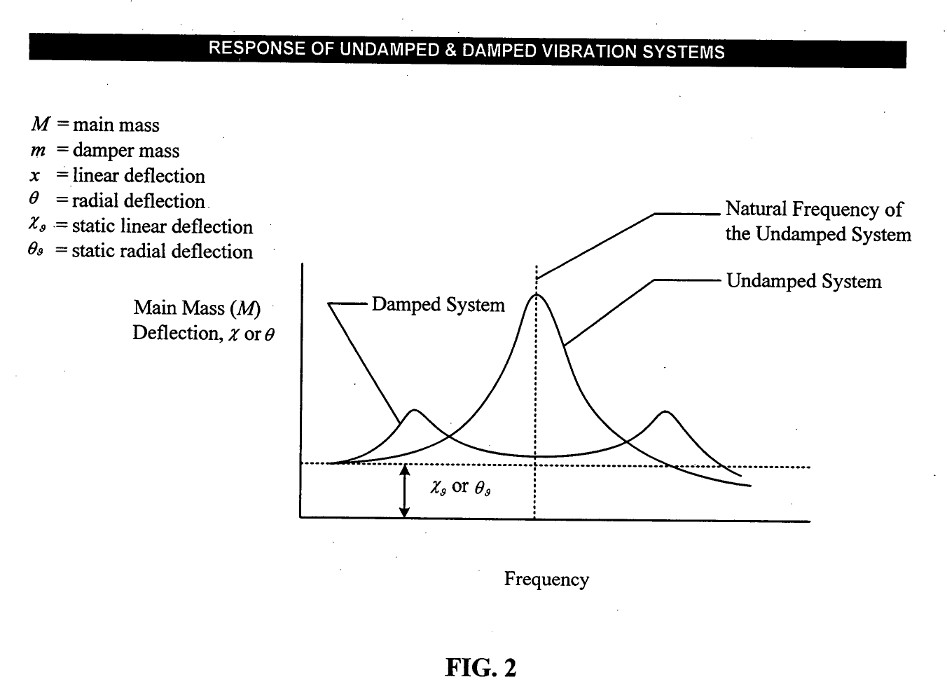

FIG. 2 illustrates an example of a response of undamped and damped vibration systems. As such, FIG. 2 reflects one general type of graphical output from an aspect of one embodiment of the invention. Various aspects of various embodiments of the invention do include, however, any type/configuration of graphical output.

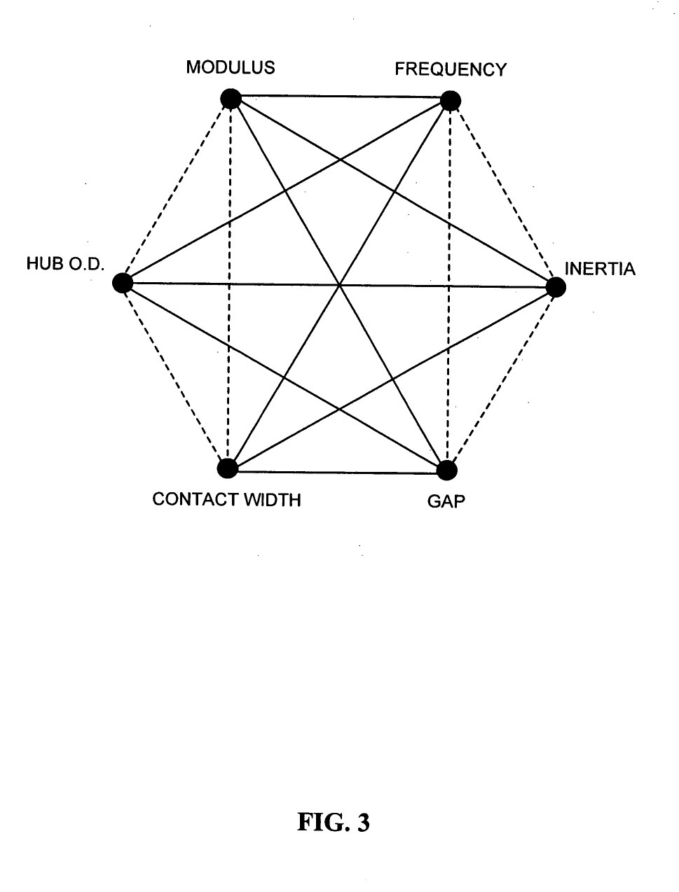

FIG. 3 is sometimes called a “damper hexagram,” and it illustrates the relationship between any two of the six key torsional damper parameters when the other four are held constant. Parameters connected by a solid line increase or decrease in value together, while parameters that are connected by a dashed line will have one parameter increase as the other one decreases, and vice versa. For example, with reference to FIG. 3, if frequency increases, then the modulus must also increase if the other four parameters are held constant. If frequency decreases, the modulus must also decrease if the other parameters are held constant. However, if frequency increases, then the gap must decrease if the other four parameters are held constant, and vice versa. The principles of FIG. 3 are incorporated into one aspect of an exemplary embodiment of the invention—design of a torsional damper.

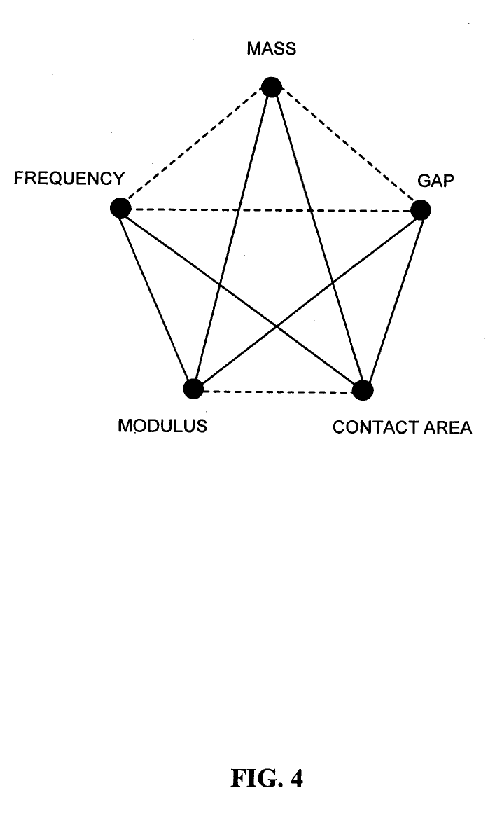

FIG. 4 is sometimes called a “damper pentagram,” and illustrates the relationship between any two of the five key linear damper parameters when the other three are held constant. Parameters connected by a solid line increase or decrease in value together, while parameters that are connected by a dashed line will have one parameter increase as the other one decreases, and vice versa. For example, with reference to FIG. 3, if frequency increases, then the modulus must also increase if the other three parameters are held constant. If frequency decreases, the modulus must also decrease if the other parameters are held constant. However, if frequency increases, then the gap must decrease if the other three parameters are held constant, and vice versa. The principles of FIG. 4 are incorporated into one aspect of an exemplary embodiment of the invention, design of a linear damper.

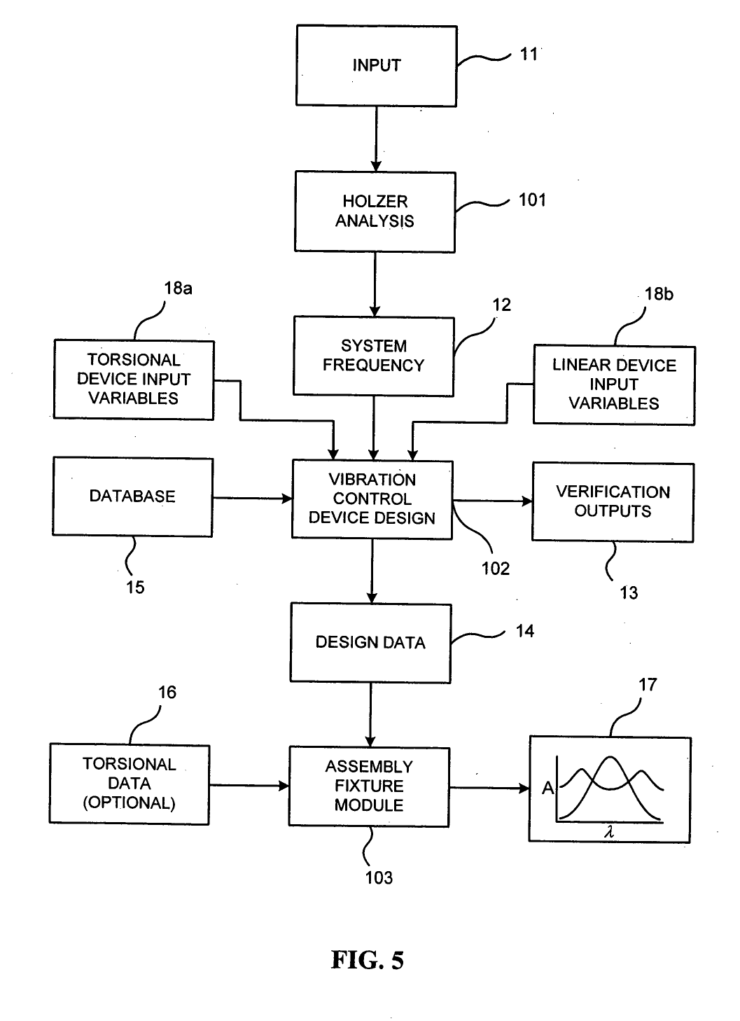

FIG. 5 is a flow diagram illustrating the three-step approach to the design of a vibration control device in accordance with aspects of an exemplary embodiment of the present invention. In accordance with the illustrated embodiment, design and analysis of a vibration control device by design system 100 begins with a Holzer analysis module 101, which utilizes user input data 11 in connection with otherwise conventional engineering algorithms to calculate the frequency of, for example, a vibrational dampening system (illustrated in FIG. 5 as output 12). Once the system frequency 12 has been determined, this data is used in connection with one or more vibration control device design modules, which may be configured to include all relevant variables, algorithms, engineering constants, and other factors necessary to complete the various aspects of the design and engineering of a selected type of vibration control device. For example, one of ordinary skill in the art will appreciate that the set of algorithms necessary to design a standard torsional damper device is different from the set of algorithms necessary to design a linear damper device. As such, in accordance with one aspect of an exemplary embodiment of the invention, a user may select from among a number of specialized design modules to comprise vibration control device design module 102. As discussed in further detail herein, when the present invention is applied to the design of certain types of vehicle engine dampening devices, for example, such specialized design modules may include algorithms for a standard torsional damper, a CV (common vertex) torsional damper, a linear (“puck”) damper, a torsional isolator, and the like.

With further reference to FIG. 5, in accordance with one aspect of an exemplary embodiment of the invention, vibration control device design module 102 is configured to optimize multiple input variables, the character of which may vary depending upon the nature of the device being designed. For example, in accordance with an embodiment of the invention in which the design system facilitates the design of a torsional dampening device, vibration control device design module 102 is configured to optimize six torsional device input variables 18a: inertia, hub outer diameter, gap, contact width, frequency (determined in Holzer analysis step 101), and shear modulus. Alternatively, for example, in accordance with another embodiment of the invention in which the design system facilitates the design of a linear dampening device, vibration control device design module 102 is configured to optimize five linear device input variables 18b: mass, contact area, gap, frequency (determined in Holzer analysis step 101), and shear modulus.

Moreover, in accordance with another aspect of the embodiment illustrated in FIG. 5, vibration control device design module 102 is configured to provide the user with verification outputs 13 such as, for example, values for shear modulus, torsional stiffness, dynamic stress, percent distortion, torque at maximum amplitude, and slip torque capability, to name a few. Values for these parameters are calculated based on user input (whether entered manually or obtained automatically by the design system module through an electronic interface) and assist the user in determining the feasibility of a particular set of design parameters. In accordance with an aspect of an exemplary embodiment of the invention, the design system is configured such that certain value ranges for the verification outputs 13 are classified as feasible and are highlighted, colorized, illuminated, or otherwise visually designated as such to the user. For example, feasible verification output parameters may appear in green typeface. Conversely, certain value ranges for the verification outputs 13 may be classified as not feasible and may be highlighted, colorized, illuminated, or otherwise visually designated as such to the user. For example, verification output parameters that are not feasible may appear in red typeface. Audible signals may also be used to alert the user to design parameters that either are feasible or are not feasible, so as to both expedite the design process and to reduce the occurrence of design error.

Moreover, in accordance with another aspect of the embodiment illustrated in FIG. 5, vibration control device design module 102 is configured to access static or dynamic data from one or more database sources 15. Database 15 may comprise, for example, historical test data on various device designs, material performance data, or any other data type that may be useful in the vibration control device design process.

With further reference to the exemplary embodiment of the invention illustrated in FIG. 5, vibration control device design module 12 provides the user with a set of design data 14 that is introduced to assembly fixture module 103. Assembly fixture module 103 provides the user with a graphical representation of the performance of the designed device in terms of its dampening effects on the experimental system. In accordance with one aspect of the invention, assembly fixture module 103 takes the design data 14 from vibration control device design module 102 and constructs a theoretical damper plot 17 comparing the natural frequency and amplitude of an undamped system with the frequency and amplitude of a system damped with the device as designed. The user can then use the plot to determine whether the device as designed achieves the desired amount of damping. Alternatively, assembly fixture module may use existing test and/or design data 16 to constructs a theoretical damper plot 17.

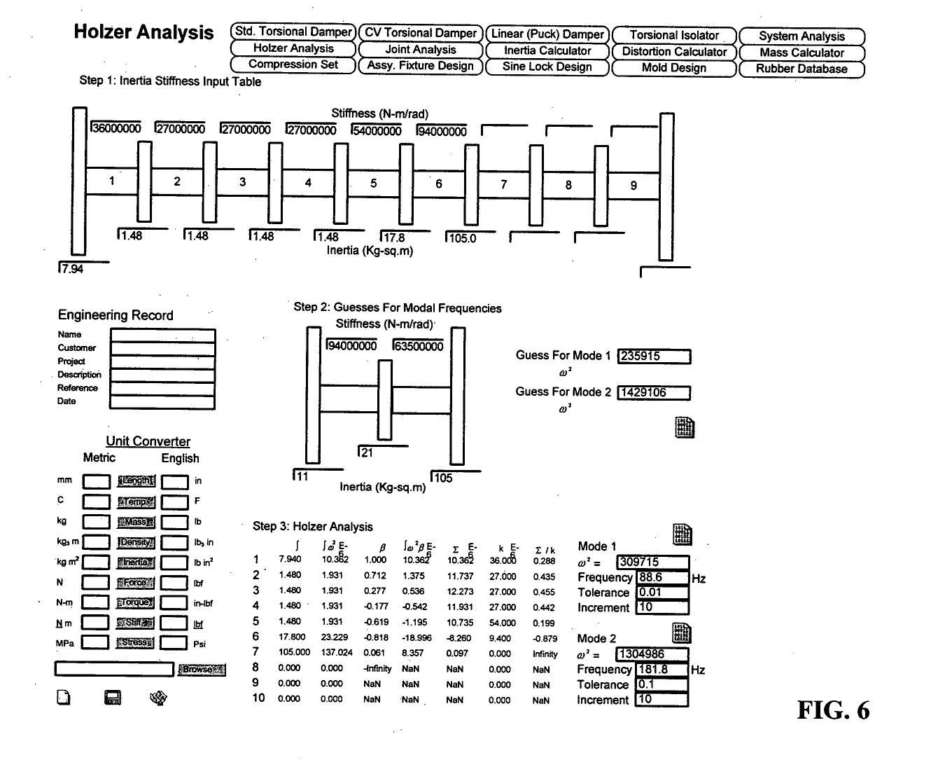

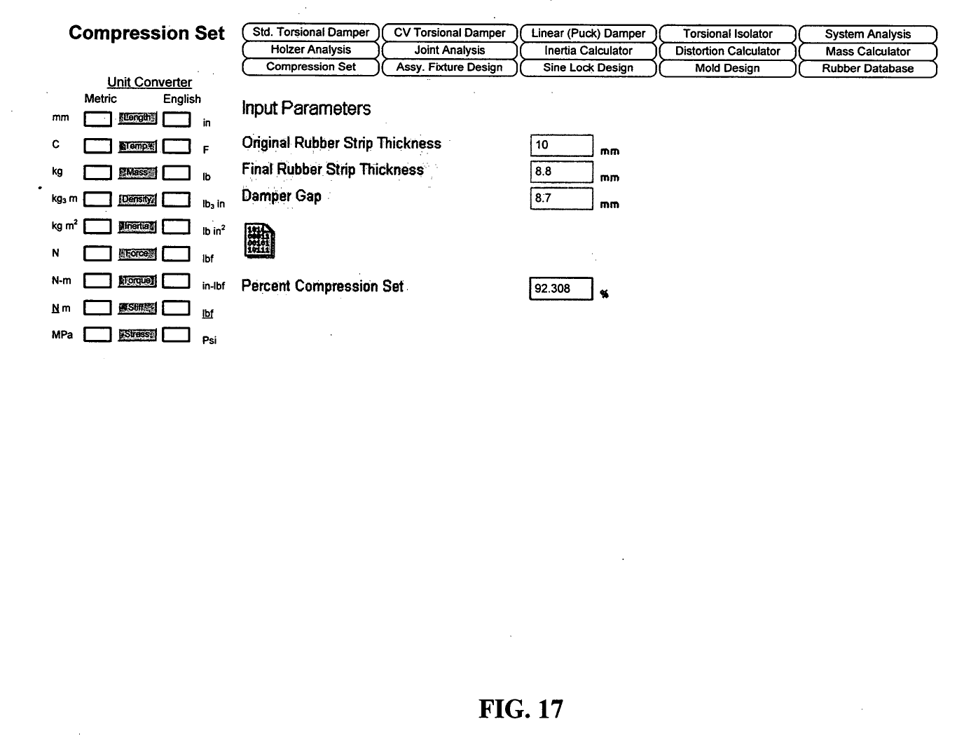

FIGS. 6 through 19 illustrate various user interface modules reflecting various functional aspects of one exemplary embodiment of the invention. While the way in which these modules may facilitate the overall design of a vibration control device will be further described herein in connection with FIG. 17, the following is a brief overview of the functionality of each of the illustrated user interface modules.

FIG. 6 illustrates a Holzer analysis module, which provides quick torsional modal solutions for damper design. The Holzer analysis module calculates guesses for modal frequencies based on user input of inertia stiffness and iterates through these guesses to determine the first two modal frequencies.

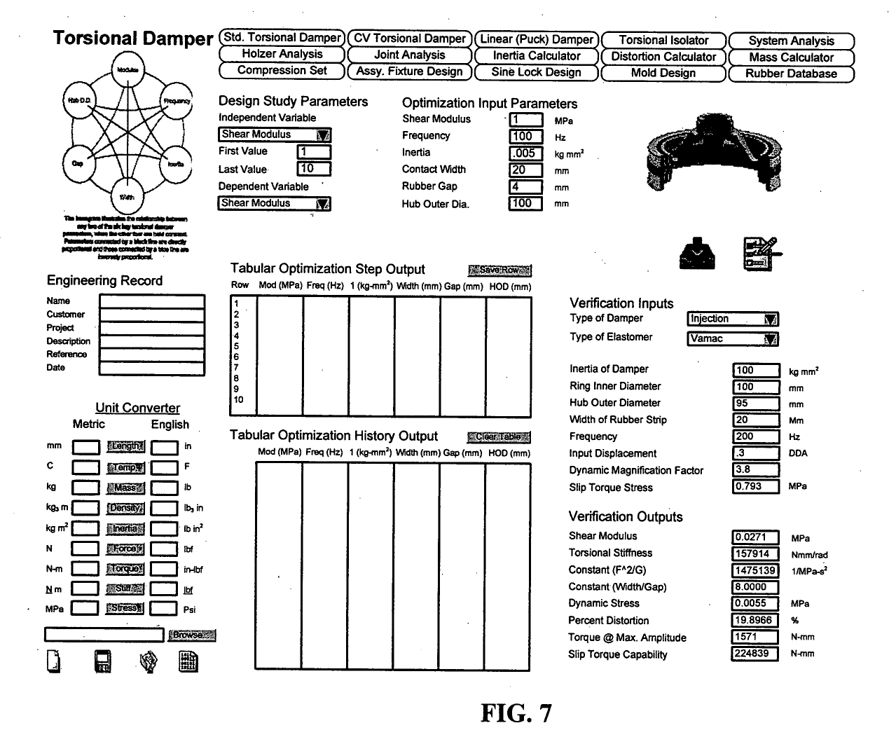

FIG. 7 illustrates a design module for a standard torsional damper. In accordance with one aspect of an exemplary embodiment of the invention, a design module for a standard torsional damper is configured to optimize six user input variables to facilitate the design of a standard torsional damper: inertia, device hub outer diameter, gap, contact width, frequency, and shear modulus.

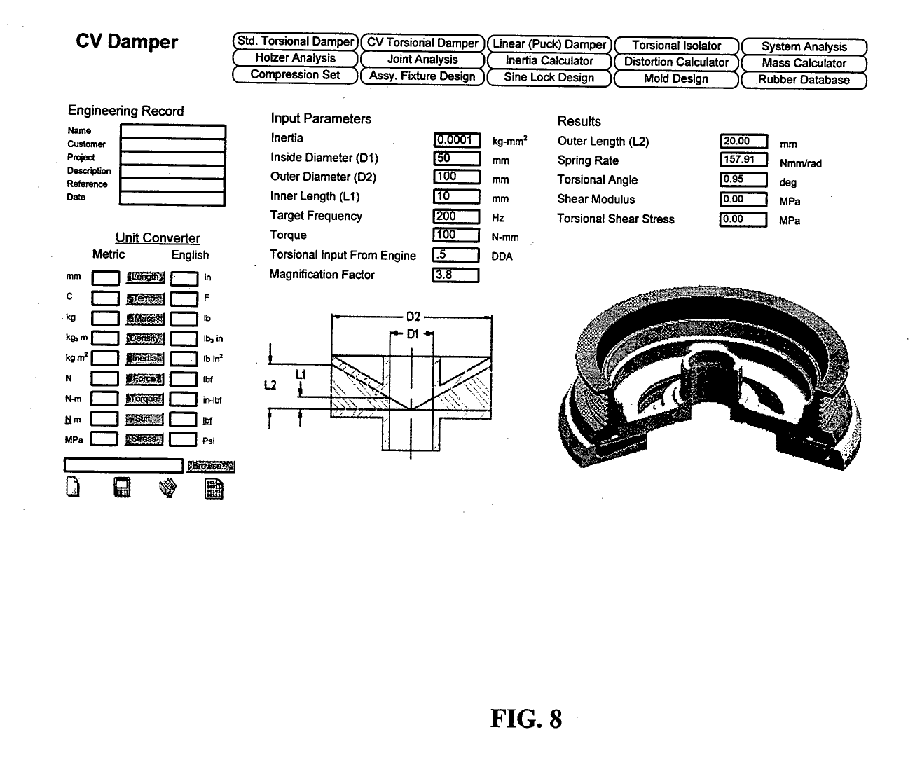

FIG. 8 illustrates a design module for a CV (common vertex) torsional damper. In accordance with one aspect of an exemplary embodiment of the invention, a design module for a CV torsional damper is configured to optimize six user input variables to facilitate the design of a CV torsional damper: inertia, device hub outer diameter, gap, contact width, frequency, and shear modulus.

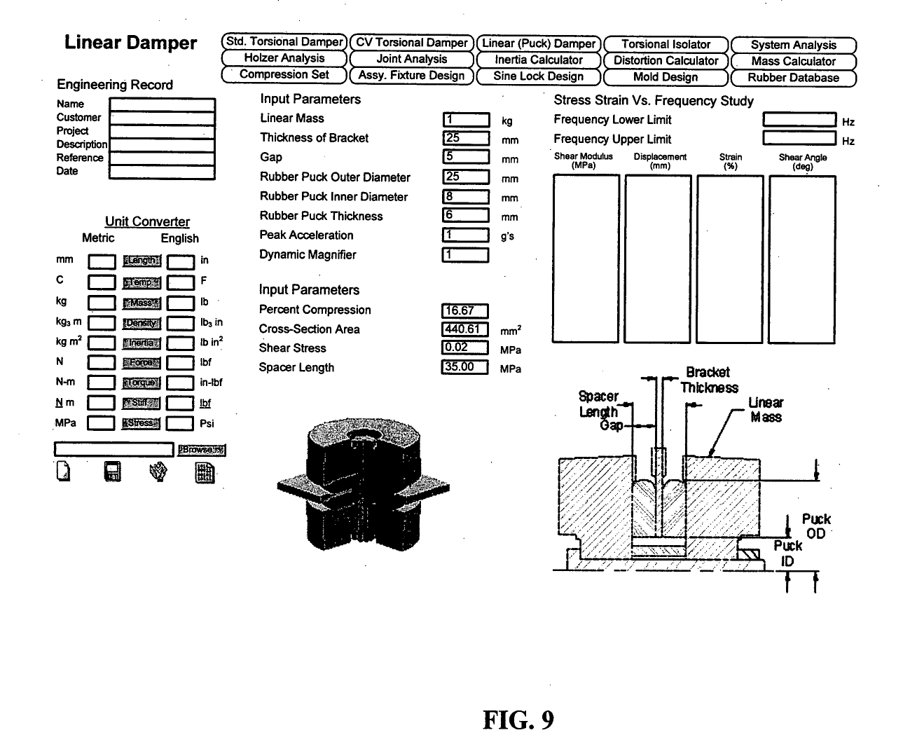

FIG. 9 illustrates a design module for a linear damper. In accordance with one aspect of an exemplary embodiment of the invention, a design module for a linear damper is configured to optimize five user input variables to facilitate the design of a CV torsional damper: mass, gap, contact area, frequency, and shear modulus.

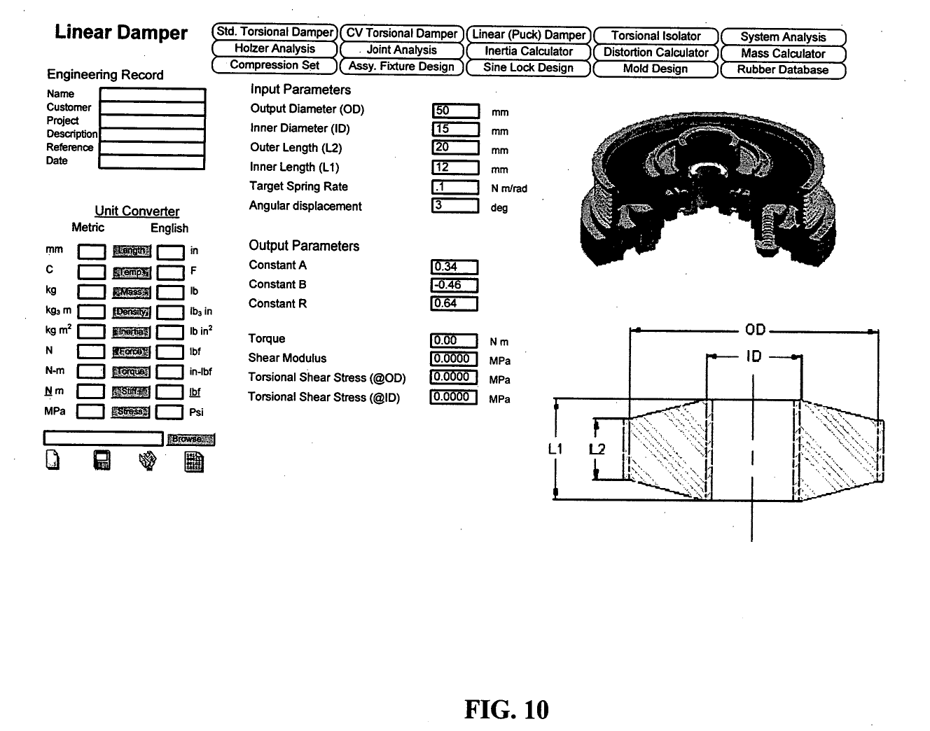

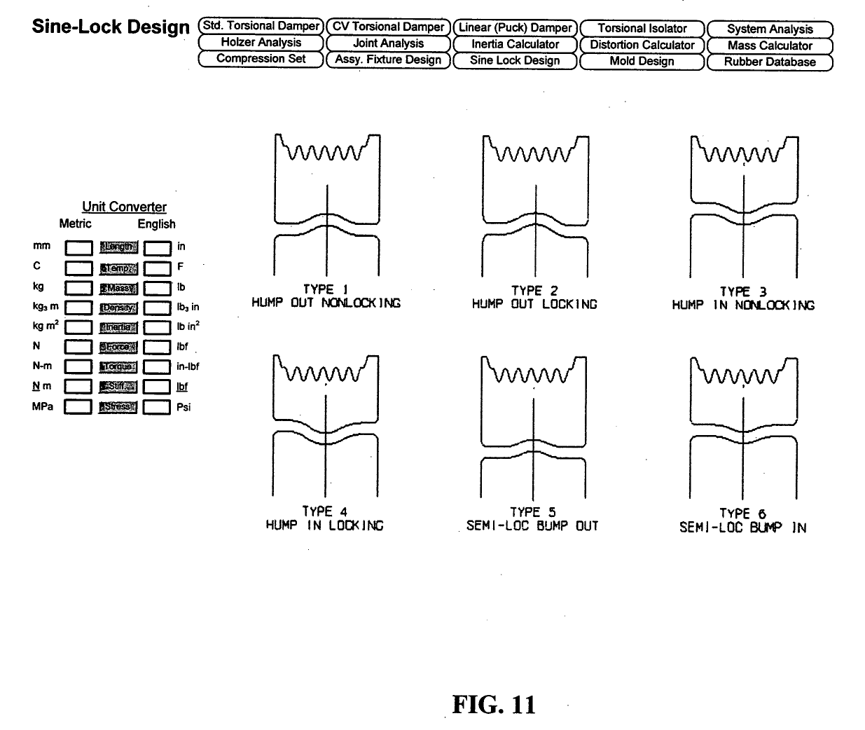

FIG. 10 illustrates a design module for a torsional isolator. Furthermore, FIG. 11 illustrates a design module for a sine-lock.

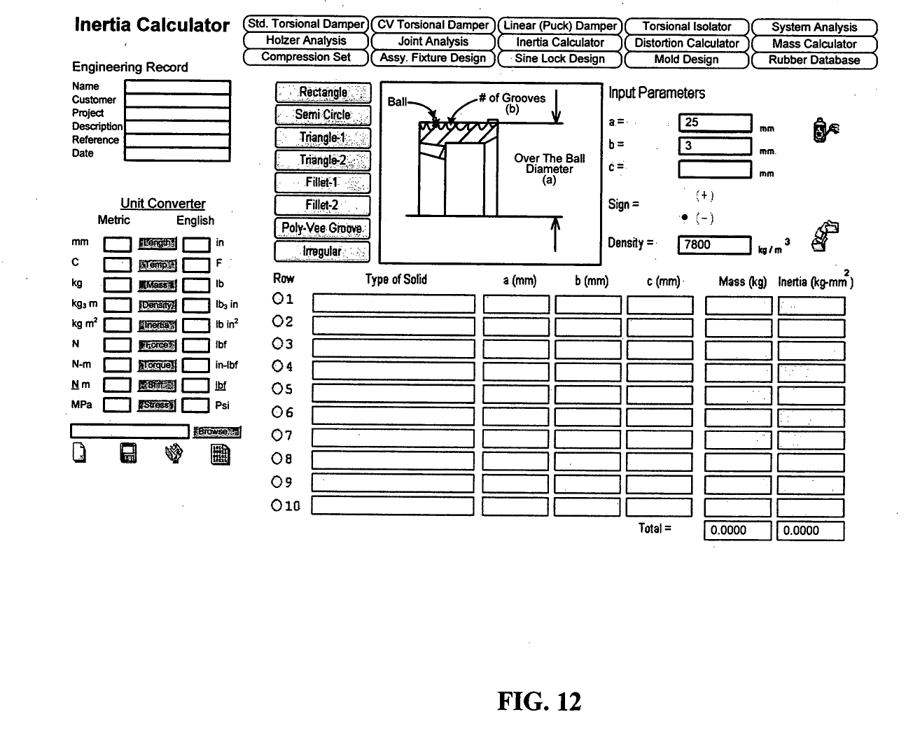

FIG. 12 illustrates an inertia calculator, which is one of various possible design tools that may be integrated into design systems configured in accordance with the present invention. In accordance with one exemplary embodiment, dimensional data are input by a user into the inertia calculator for calculation of an inertia value. In accordance with another exemplary embodiment, the inertia calculator may interface with a computer aided design (CAD) program to automatically retrieve dimensional data for input into the calculator, without requiring the user to manually enter such data.

In accordance with another exemplary aspect of an embodiment of the invention, a design system includes one or more modules configured to facilitate the choice of materials for a vibration control device based on the desired physical properties of the materials as they relate to the overall design of the device. For example, in accordance with one embodiment of the invention, the design system includes a module configured to assist the user in selecting an appropriate rubber material for use in a vibration control device, such as an engine damper or torsional isolator. Selecting an appropriate material for a particular application requires consideration of a number of physical properties of the materials, such as, for example, dynamic shear modulus versus temperature characteristics. In accordance with one aspect of an exemplary embodiment of the invention, the design system may access theoretical data and/or actual test data relating to one or more desired physical properties for a variety of materials, such as, for example, natural rubber, styrene-butadiene, polychloroprene, nitrile, ethylene propylene, polyacrylates, ethylene acrylic, polybutadiene, polyisoprene, bromobutyl, and other rubber materials for use in connection with an engine damper or torsional isolator.

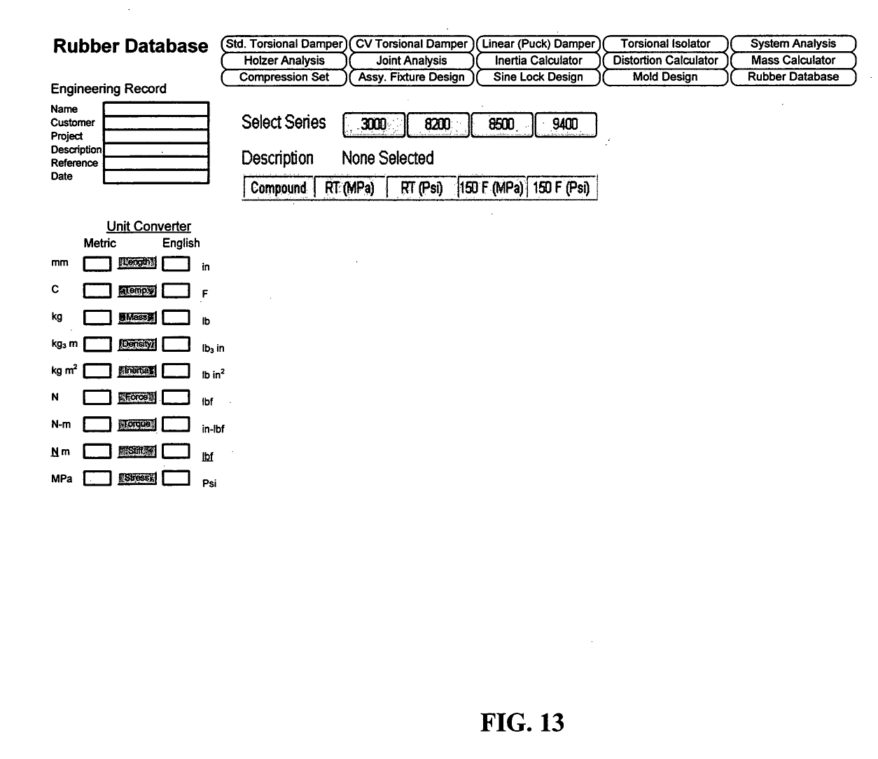

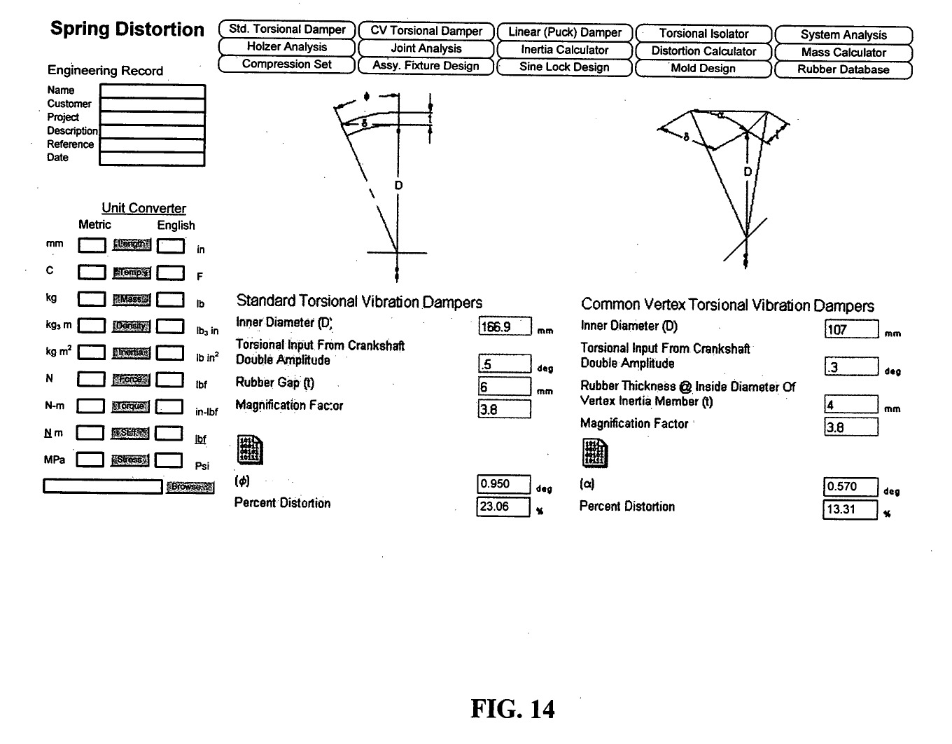

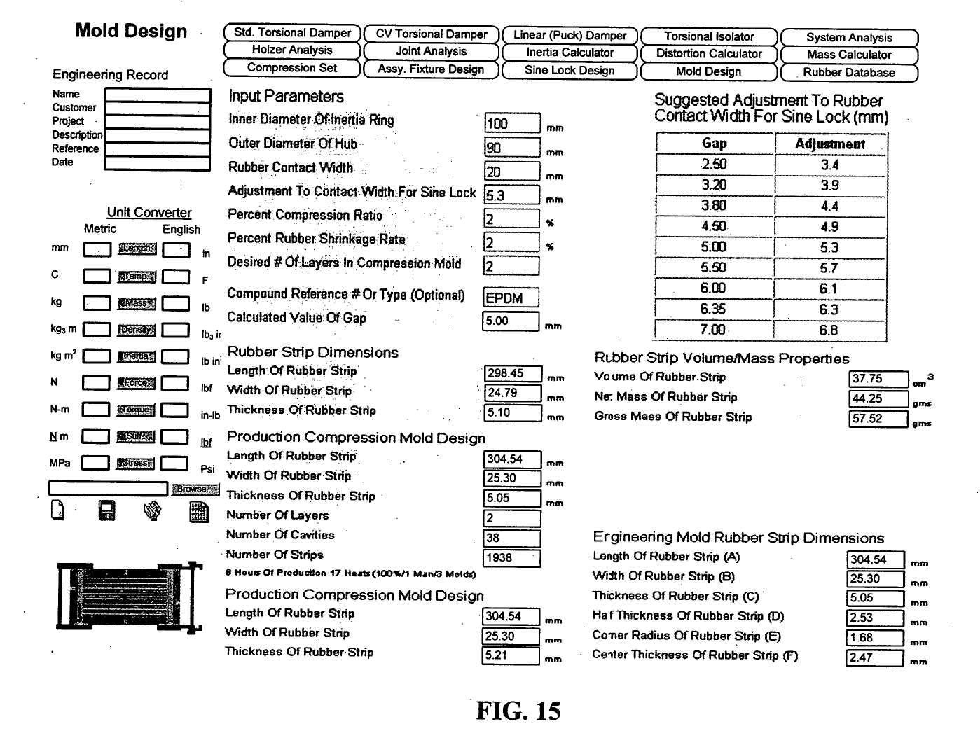

In accordance with one exemplary aspect of an embodiment of the invention, actual material test data may be imported to one or more design system modules to enable “real life” design parameters that may differ slightly from theoretical optima. For example, as illustrated in FIG. 13, values for shear modulus (MPa) of various rubber compounds for use in connection with a damper device may be imported to the design system and utilized in connection with one or more design modules-such as, for example, a rubber distortion calculator (FIG. 14), a mold design module (FIG. 15; illustrates what a designer needs to do to make a compression or insertion mold for elastomeric portion of the device), and/or any of the specific damper design modules illustrated in FIG. 7 (standard torsional damper design module), FIG. 8 (common vertex torsional damper design module), FIG. 9 (linear damper design module), and FIG. 10 (torsional isolator design module).

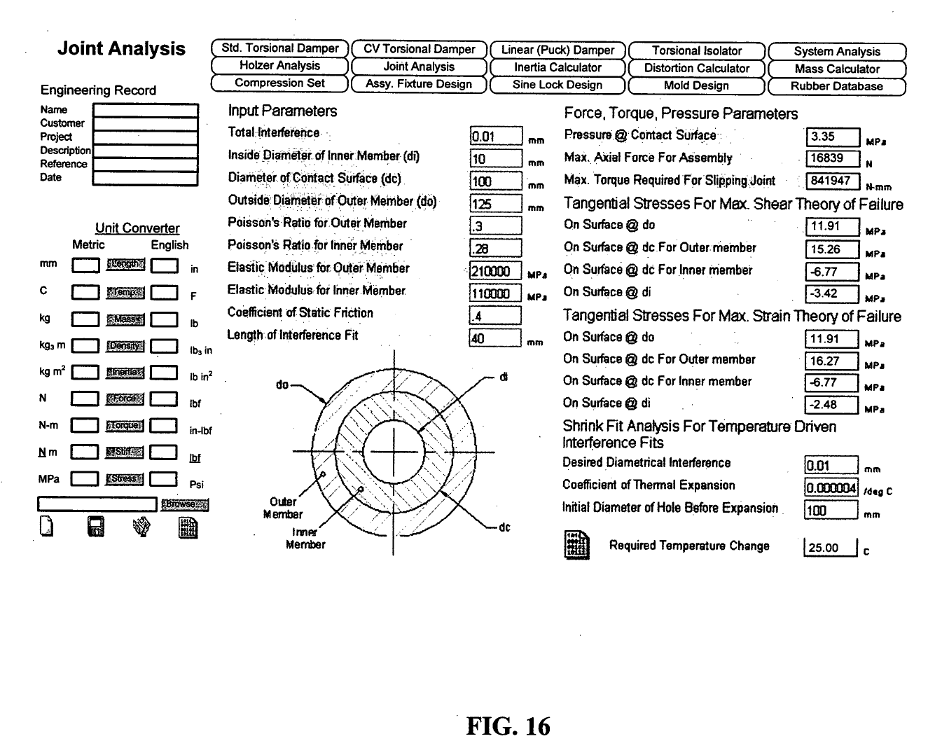

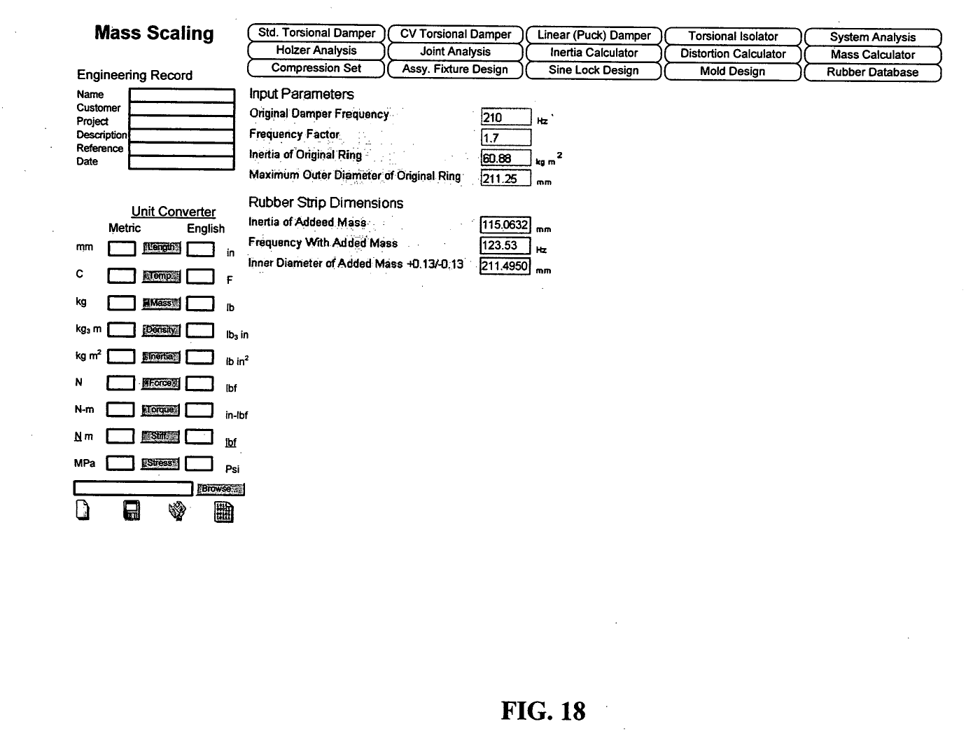

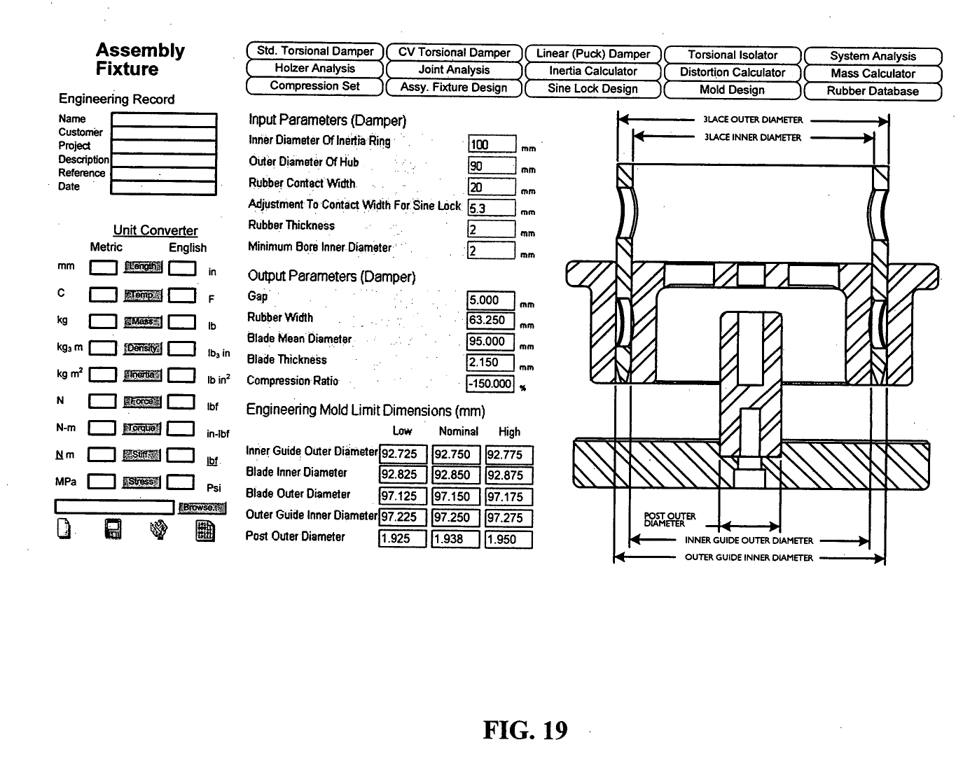

FIG. 16 illustrates a joint analysis calculator; FIG. 17 illustrates a compression set calculator; FIG. 18 illustrates a mass scaling calculator; and FIG. 19 illustrates an assembly fixture calculator, all of which are additional tools that may be integrated into design systems configured in accordance with the present invention. Those skilled in the art will recognize that other design tools may be incorporated into various embodiments of the present invention in addition to those illustrated herein.

It should be understood that various principles of the invention have been described in illustrative embodiments only, and that many combinations and modifications of the above-described structures, arrangements, proportions, elements, materials and components, used in the practice of the invention, in addition to those not specifically described, may be varied and particularly adapted to specific users and their requirements without departing from those principles.

1. A system for designing a vibration control device, comprising:
a host computer, comprising:
a memory configured to store at least two programs selected from the group consisting of a Holzer analysis module, a sine-lock design module, a standard torsional damper design module, a common vertex torsional damper design module, a linear damper design module, a torsional isolator design module, an inertia calculator, a rubber database, a rubber distortion calculator, a mold design module, a joint analysis calculator, a compression set calculator, a assembly fixture module, and a mass scaling calculator, consolidated on a single computer platform, and
circuitry configured to execute said at least two programs together; and
a display device configured to display said at least two programs coupled to said host computer.

2. The system of claim 1, wherein said at least two programs are configured to import data from each other.

3. The system of claim 1, wherein said memory is configured to store a Holzer analysis module, a sine-lock design module, a standard torsional damper design module, a common vertex torsional damper design module, a linear damper design module, a torsional isolator design module, an inertia calculator, a rubber database, a rubber distortion calculator, a mold design module, a joint analysis calculator, a compression set calculator, a assembly fixture module, and a mass scaling calculator, and wherein all of said modules are consolidated on a single computer platform.

4. The system of claim 1, wherein one of said at least two programs is said Holzer analysis module.

5. The system of claim 4, wherein another of said at least two programs is said sine-lock design module.

6. The system of claim 4, wherein another of said at least two programs is said standard torsional damper design module.

7. The system of claim 4, wherein another of said at least two programs is said common vertex torsional damper design module.

8. The system of claim 4, wherein another of said at least two programs is said linear damper design module.

9. The system of claim 4, wherein another of said at least two programs is said torsional isolator design module.

10. A computer-implemented method for designing a vibration control device, comprising the steps of:
consolidating at least two programs selected from the group consisting of a Holzer analysis module, a sine-lock design module, a standard torsional damper design module, a common vertex torsional damper design module, a linear damper design module, a torsional isolator design module, an inertia calculator, a rubber database, a rubber distortion calculator, a mold design module, a joint analysis calculator, a compression set calculator, a assembly fixture module, and a mass scaling calculator onto a single computer platform.

11. The method of claim 10, further comprising the step of:
importing data from a first program of said at least two programs to a second program of said at least two programs.

12. The method of claim 10, wherein the consolidating step comprises the step of:
consolidating each of said programs on said computer platform.

13. The method of claim 10, wherein the consolidating step comprises the step of:
consolidating said Holzer analysis module and at least one additional program of said group on said computer platform.

14. The method of claim 10, wherein the consolidating step comprises the step of:
consolidating said Holzer analysis module and said sine-lock design module on said computer platform.

15. The method of claim 10, wherein the consolidating step comprises the step of:
consolidating said Holzer analysis module and said standard torsional design module on said computer platform.

16. The method of claim 10, wherein the consolidating step comprises the step of:
consolidating said Holzer analysis module and said common vertex torsional damper design module on said computer platform.

17. The method of claim 10, wherein said consolidating step comprises the step of:
consolidating said Holzer analysis module and said linear damper design module on said computer platform.

18. The method of claim 10, wherein the consolidating step comprises the step of:
consolidating said Holzer analysis module and said torsional isolator design module on said computer platform.

19. A machine-readable medium having stored thereon a plurality of instructions, said plurality of instructions when executed by a processor, cause the processor to perform a method comprising the step of:
consolidating at least two programs selected from the group consisting of a Holzer analysis module, a sine-lock design module, a standard torsional damper design module, a common vertex torsional damper design module, a linear damper design module, a torsional isolator design module, an inertia calculator, a rubber database, a rubber distortion calculator, a mold design module, an joint analysis calculator, a compression set calculator, a assembly fixture module, and a mass scaling calculator onto a single computer platform.

20. The machine-readable medium of claim 19, wherein the consolidating step comprises the step of:
consolidating said Holzer analysis module and at least one of said sine-lock design module, said standard torsional damper design module, said common vertex torsional damper design module, said linear damper design module, and said torsional isolator design module.
